(19) United States
(12) Patent Application Publication
(10) Pub. No.: US 2010/0062325 A1
(43) Pub. Date: Mar. 11, 2010

(54) BATTERY HOLDER

(75) Inventor: Wen-Ze Liu, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/337,741

(22) Filed: Dec. 18, 2008

(30) Foreign Application Priority Data
Sep. 8, 2008 (CN) 200810304411.4

(51) Int. Cl. H01M 2/10

(52) U.S. Cl. 429/100

(57) ABSTRACT

A battery holder (10) is provided. The battery holder (10) includes a body member (11) defining a battery receiving space (113), a latching member (13) fixed to the body member (11) and a battery (12) received in the battery receiving space (113). The latching member (13) includes a latching portion (133). The battery (12) defines a first latching groove (1221). The latching portion (133) latches into the first latching groove (1221).

### BACKGROUND

1. Field of the Invention

The present invention relates to battery holders and particularly, to a battery holder used in a portable electronic device.

2. Description of related art

Portable electronic devices are typically powered by internal batteries. A battery holder is provided to fasten the battery within the electronic device.

The battery holder typically includes a body member and a latching assembly fixed to the body member. The body member defines a receiving space to receive the battery. The latching assembly includes a button, a plurality of protrusions and a spring. The button is slidably mounted on the body member adjacent to the receiving space. The protrusions are configured for biasing the spring to secure the battery in the receiving space and are released by the button.

However, such battery holder can be complex in structure, and inconvenient for users to remove the battery out of the receiving space.

Therefore, there is room for improvement within the art.

### BRIEF DESCRIPTION OF THE DRAWINGS

Many aspects of the battery holder can be better understood with reference to the following drawings. These drawings are not necessarily drawn to scale, the emphasis instead being placed upon clearly illustrating the principles of the present battery holder. Moreover, in the drawings like reference numerals designate corresponding sections throughout the several views.

FIG. 1 is an exploded, isometric view of a battery holder, in accordance with an exemplary embodiment.

FIG. 2 is a partially enlarged view of the battery holder shown in FIG. 1.

FIG. 3 is another partially enlarged view of the battery holder shown in FIG. 1.

FIG. 4 is an isometric view of the latching member shown in FIG. 1.

FIG. 5 is an isometric view of the body member incorporating the latching member shown in FIG. 1.

FIG. 6 is another isometric view of the body member incorporating the latching member shown in FIG. 1.

FIG. 7 is an isometric, assembled view of the battery holder shown in FIG. 1.

### DETAILED DESCRIPTION OF EXEMPLARY EMBODIMENT

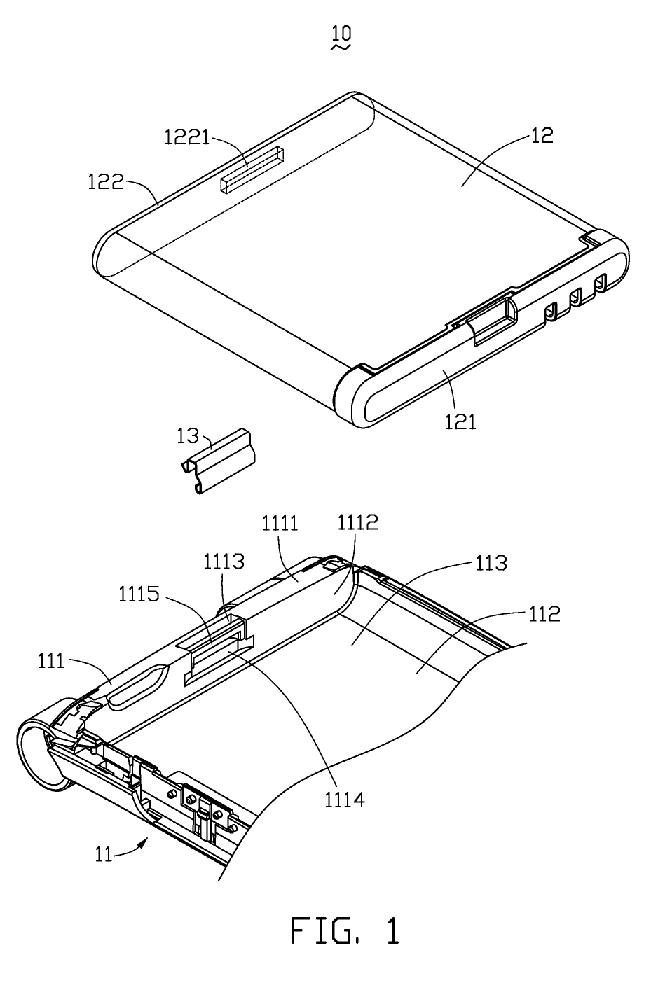

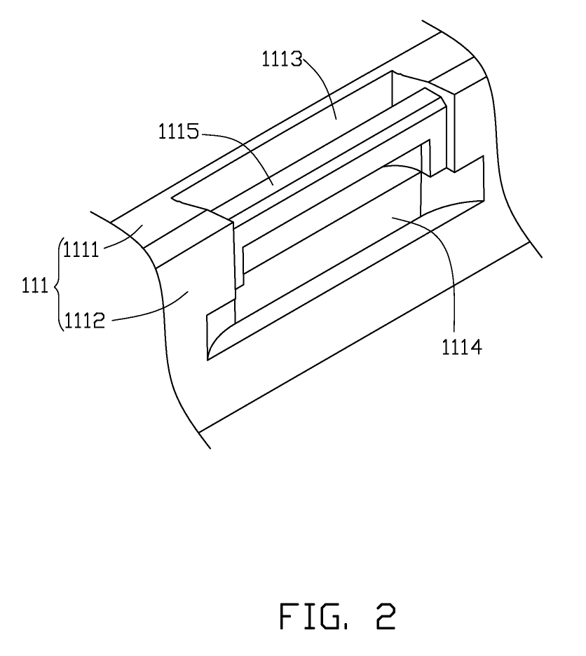

FIGS. 1 and 2 show an exemplary battery holder 10 for portable electronic devices, such as mobile phones, digital cameras and etc. The battery holder 10 includes a body member 11, a battery 12, and a latching member 13.

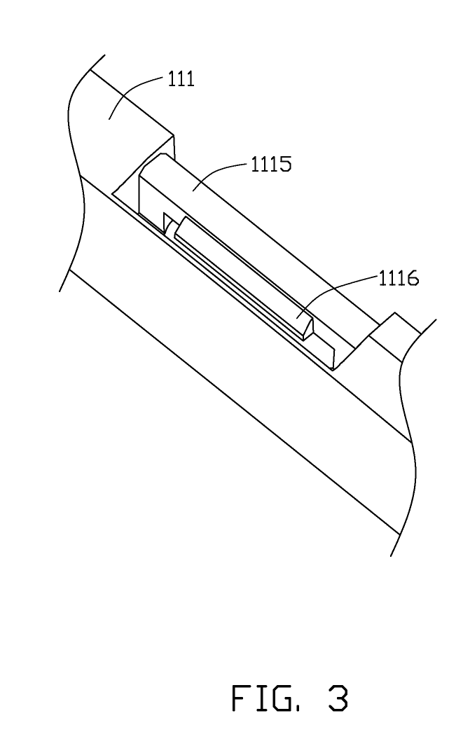

The body member 11 includes a peripheral wall 111 and a bottom wall 112. The peripheral wall 111 and the bottom wall 112 enclose a battery receiving space 113. The body member 11 may be a portion of the body section of the portable electronic device. The peripheral wall 111 includes a top surface 1111 and an interior surface 1112. The top surface 1111 defines a cavity 1113. The interior surface 1112 defines a slot 1114 communicating with the cavity 1113. By defining of the cavity 1113 and the slot 1114, the peripheral wall 111 forms a hanging pole 1115. The hanging pole 1115 is parallel with the bottom wall 112. Referring to FIG. 3, a latching block 1116 protrudes from the hanging pole 1115 towards the peripheral wall 111.

The battery 12 includes a top 121 and a bottom 122. The bottom 122 defines a first latching groove 1221 at a central portion thereof.

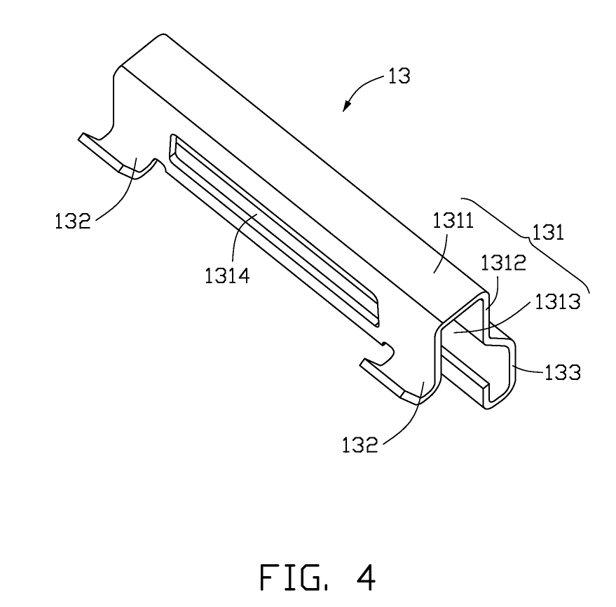

Referring to FIG. 4, the latching member 13 is an elastic sheet including a fastening portion 131, two resisting portions 132 and a latching portion 133. The fastening portion 131 is generally U-shaped, including a top portion 1311 and two opposite side portions 1312. A gap 1313 is defined between the top portion 1311 and the two side portions 1312. One of the side portions 1312 defines a second latching groove 1314 corresponding to the latching block 1116. The resisting portions 132 protrude upwardly from the side portion 1312 with the second latching groove 1314. The latching portion 133 protrudes from the other side portion 1312, firstly downwardly and then upwardly.

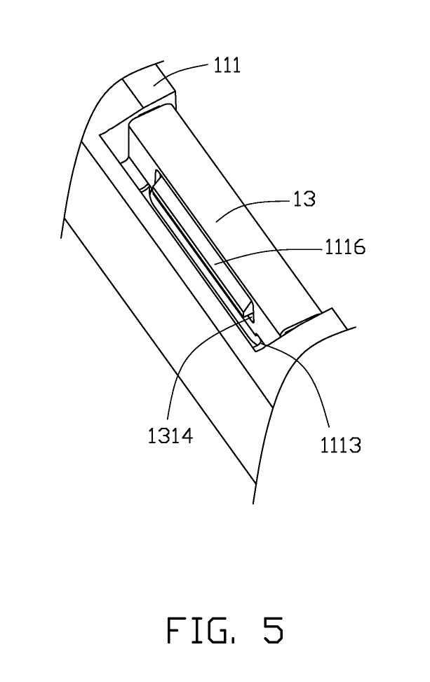

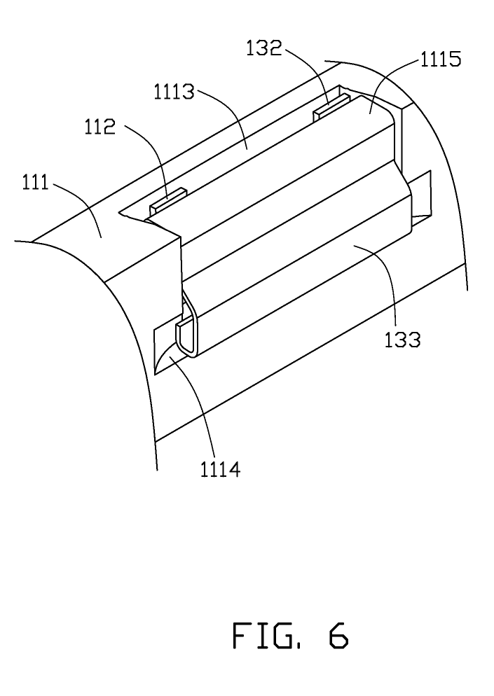

Referring to FIGS. 5 and 6 together, during assembly, the latching member 13 is aligned with the hanging pole 1115. Then, the resisting portions 132 are deformably pressed into the cavity 1113 until the latching block 111 6 latches into the second latching groove 131 4. At this time, the resisting portions 132 deformably resisting the peripheral wall 111, and the hanging pole 1115 is secured in the gap 1313.

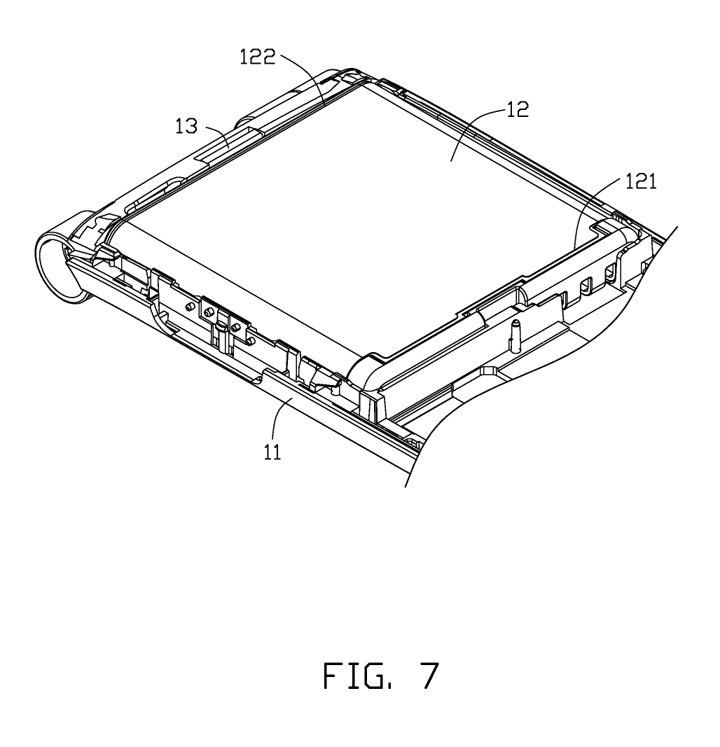

FIGS. 6 and 7 show the holding state of the battery holder 10. To hold the battery 12, the top 121 of the battery 12 is placed in the receiving space 113. The bottom 122 of the battery 12 is pivoted about the top 121 to the battery receiving space 113 until the latching portion is biased and latched into the first latching groove 1221. To release the battery 12 from the battery receiving space 113, an external force is applied to the bottom 122 of the battery 12 to pivote the bottom 122 about the top 121 of the battery 12. At this stage, the latching portion is biased again and released out of the latching groove 1221. At this time, the battery 12 can be easily removed from the battery receiving space 113.

In the holding position, the battery holder 10 fastens the battery 12 by using the latching member 13. Thus, the battery holder 10 is simple in structure and convenient to operate.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A battery holder, comprising:
a body member defining a battery receiving space;
a latching member fixed to the body member, the latching member including a latching portion; and
a battery defining a first latching groove, the battery being received in the battery receiving space, the latching portion latching into the first latching groove.

2. The battery holder as claimed in claim 1, wherein the body member includes a bottom wall and a peripheral wall, the bottom wall and the peerphery wall enclosing the battery receiving space.

3. The battery holder as claimed in claim 2, wherein the peripheral wall includes a top surface and an interior surface facing the battery receiving space, the top surface defining a cavity, the interior surface defining a slot communicating with the cavity, thus forming a hanging pole on the peripheral wall.

4. The battery holder as claimed in claim 3, wherein the latching member is an elastic sheet, further including a fastening portion, the fastening portion includes a top portion and two opposite side portions, forming a gap between the top portion and the two side portions, the top portion is used to secure the hanging pole therein, the latching portion protruding from one of the two side portions.

5. The battery holder as claimed in claim 4, wherein the other side portion defines a second latching groove, a latching block protruding from the hanging pole facing the peripheral wall, the latching block latching into the second latching groove.

6. The battery holder as claimed in claim 5, wherein the latching member further includes a resisting portion, the resisting portion protrudes from the side portion with the second latching groove, and the resisting portion abuts against the peripheral wall.
